(19) United States
(12) Patent Application Publication
(10) Pub. No.: US 2015/0079237 A1
(43) Pub. Date: Mar. 19, 2015

(54) SYSTEM FOR PREPARING INSTANT FOOD AND METHODS OF MAKING THEREOF

(71) Applicants: ALY GAMAY, Mclean, VA (US); Chris Broadhurst, Sterling, VA (US)

(72) Inventors: ALY GAMAY, Mclean, VA (US); Chris Broadhurst, Sterling, VA (US)

(21) Appl. No.: 14/480,223

(22) Filed: Sep. 8, 2014

Related U.S. Application Data
(60) Provisional application No. 61/877,958, filed on Sep. 14, 2013.

(51) Int. Cl. A23L 1/00; A23L 1/01; A23L 1/182; A23L 1/40; A23L 1/212

(52) U.S. Cl. CPC A23L 1/0008; A23L 1/40; A23L 1/212; A23L 1/182; A23L 1/0121; A23V 2002/00
USPC 426/86; 426/431; 426/436; 426/437; 426/394

(57) ABSTRACT

The present invention describes methods for preparing instant food and snacks and the making of an instant liquid meal or snack. The invention teaches a technique of preparing single-serve instant liquid and solid meals or snacks to be cooked in same container using commercial brewers and preparation equipment.

A kit that contains dry food components that get cooked in the same container resulting in a liquid meal with solid particulates is described.

### CROSS-REFERENCE TO RELATED APPLICATIONS

This application claims the benefit of U.S. Provisional Application No. 61/877,958, filed Sep. 14, 2013. The entire disclosure of this prior application is hereby incorporated by reference.

### FIELD OF INVENTION

The present invention is generally related to the field of instant food, and more particularly to the making of an instant liquid meal or snack. More specifically, the present invention is directed to a technique of preparing single-serve instant liquid and solid meals or snacks to be cooked in same container using commercial brewers and preparation equipment.

This invention further relates to a kit that contains dry food components that get cooked in the same container resulting in a liquid meal with solid particulates. The kit may deliver savory, sweet or nutritional foods.

### BACKGROUND OF THE INVENTION

This invention pertains to preparing an instant food containing solid and liquid phases that could be cooked in a household or industrial brewing machine.

In recent years there has been a substantial increase in the number and variety of instantly prepared foods available to the consumer. Soup is a very popular meal but preparation from raw ingredients at home is usually time consuming, difficult and more expensive than use of instantly prepared foods. The homemaker therefore has turned to canned, dry or instantly prepared soups. The soup may come in the form of dry granules, dry compacted, concentrated liquids which may be mixed with water and heated. Diluted canned soups could be heated and served. Various particles and foods maybe included in the soup, ranging from vegetable, starchy, poultry, beef and herbal ingredients.

Single-serve food and beverages are becoming increasingly popular and convenient foods are gaining popularity with advancement of food innovations.

For instance, consumers demand convenience and quality in newly introduced beverage innovations. There are a number of schemes for providing devices for making a single beverage server, such as a cup of coffee or tea. In one approach a disposable container fits on top of a cup and has a compartment for receiving a beverage extract such as coffee with a large reservoir on top into which a person must pour boiling water. U.S. Pat. No. 5,325,765 describes a beverage filter cartridge that includes an impermeable pierceable base having a predetermined shape and an opening at one end; a self-supporting wettable filter element disposed in the base sealingly engages with the opening in the base and has a form different and smaller than the predetermined shape of the base so that the filter element diverges from the base and divides the base into two sealed chambers, a first chamber for storing an extract of the beverage to be made, and a second empty chamber for accessing the beverage after the beverage outflow from the filter has been made by combining a liquid with the extract; and an impermeable pierceable cover sealingly engaged with the opening in the base to form an impermeable cartridge. That disposable container proved to be very popular due to delivering a quality cup of coffee in a convenient manner.

Single-serve brewing machines produce one cup of coffee, tea, or hot chocolate at a time using a single-serve cartridge. An example of a single-serve brewing machine is the brewing system manufactured by Keurig, Inc., which uses single-serve K-Cup® cartridges that are also manufactured by Keurig, Inc. The single-serve cartridge is a small plastic cup designed for placement within the single-serve brewing machine, and contains several elements including a foil lid, a plastic outer shell, and usually a filter. For instance, a single-serve cartridge that brews coffee or tea has a filter to hold the coffee grinds or tea leaves in place. In contrast, a single-serve cartridge that brews hot chocolate typically does not contain a filter.

To use a single-serve cartridge, a user places the cartridge within a single-serve brewing machine, closes the lid of the machine and presses a brew button. The machine contains an inlet needle and an outlet needle, which penetrate the top and bottom, respectively, of the cartridge. The machine injects heated water through the inlet needle into the cartridge, and drains the brewed beverage from the bottom of the cartridge through the outlet needle into the user's cup. Once the beverage has been brewed, the cartridge is removed from the machine and discarded.

Such brewers gained tremendous popularity and almost exist in more than 10% of American households and offices. It would be highly desirable to be able to utilize such brewers to prepare hot meals and snacks like soup and breakfast preparation. However, that approach may not provide an instant meal due to the need for having a filter which limits the amount of solid food that may be included in the cup or capsule. Furthermore, mixing powders with solid food like pasta, rice, oatmeal and meat may cause the filter to clog and may cause the explosion of the capsule.

Thus, a well-established need continues to exist for a system that enables a liquid food product with one or more pieces of solid food, such as soups or cooked cereals, to be made utilizing a needle-based brewing machine.

### SUMMARY

The present invention is directed to a technique of producing an instant liquid and solid meal with enhanced aroma and flavor in a single serve capsule that could be infused with water in a brewing machine.

The method enables a liquid food product with one or more pieces of solid food, such as soup, to be made utilizing a needle-based brewing machine. For example, the kit can contain a dry soup extract and dried pieces of solid food such as fruits, meat, vegetable or grains.

The invention describes the method of creating a natural food filter that prevents clogging of the outflow port of the cup or capsule, thus eliminating the need for inserted filters or additional compartments inside the cup or capsule. Furthermore, the invention teaches the criteria needed for selecting the solid food component and sequence of layering edible solid ingredients. The outer shell of the kit is pierceable to accommodate an injection of water into the container for combination with the soup extract to produce a broth which outflows from the bottom of the pierced container. The solid food pieces get rehydrated when infused with water. The capsule is configured with peelable lids to allow a user to peel back the lids and pour the cooked solid contents, into the user's brewed broth. To create a cup of soup, for example, the user can place the container into the brewing machine and press the brew button. The lid and the bottom of the capsule are pierced by the brewing machine's needles. Heated water flows through the capsule and mix with the soup extract forming a broth, which can exit the container into the user's cup through the outflow needle of the brewing machine. When the water flow is complete, the container is transferred from the brewing machine and the peelable lid removed in order to pour cooked solid food contents into cup of broth.

The processing of the kit is described to allow the necessary configuration of solid and dry ingredients inside the cup.

The present invention further relates to a system and methods for producing individual dosages or single-serve packs of instant foods.

Another object of the invention is to provide a process for packaging instant shelf-stable ingredients such as meat, grains, and vegetable and/or spice sources for long term storage under non-refrigerated or non-freezing conditions without a loss of desirable taste and aroma characteristics or any microbial spoilage, yet deliver hot instant meal preparation in a convenient manner.

A further object of the invention is to provide instant convenient cold drinks, smoothies and iced beverages with detectable particulates and pieces.

A further object of the invention is produce instant breakfast meals that contains grains, dairy and non-dairy milk and/or softened fruit particles.

Other objects, features and advantages of the present invention will be apparent from these summary and description of preferred embodiments, and will be readily apparent to those skilled in the art having knowledge of gelled products/compositions and their methods of preparation. Such objects, features, benefits and advantages will be apparent from the above as taken in conjunction with the accompanying examples, tables, data and all reasonable inferences to be drawn there from.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

“Shelf stable” means a food product that is microbiologically and chemically stable at ambient temperature without refrigeration or freezing.

As used herein, the term “instant soluble food source component” means a food product ingredient comprising soluble, instant, dried, freeze dried or spray dried ingredients to impart nutritional, textural, appearance, taste or flavor impact like colors, flavors, sweeteners, salting and texturing agents. This component dissolves instantly upon the addition of warm or hot water.

As used herein, the term “solid food source component” means a food product ingredient comprising meat, vegetable, fruit or fat or other food categories.

As used herein, the term “starch source component” is defined as single or blended sources derived from a natural origin. It may include pasta, noodles, rice, grain, thickener and other starch analogs. The preferred starch component is produced by freeze drying, pulverization, instantizing, quick drying, and pre-cooking frying or par-frying to induce instant characteristics suitable for instant hydration upon contact with heated water.

As used herein, the term “meat source component” is defined as single or blended sources derived from a natural origin. It may include poultry, beef, seafood and other meat analogs. The preferred meat component is produced by freeze drying or pulverization to induce instant characteristics suitable for instant hydration upon contact with heated water.

The term “vegetable source component” is defined as single or blended sources derived from a natural origin. It may include real vegetable or other vegetable analogs. The preferred vegetable component is produced by drying, freeze drying or pulverization to induce instant characteristics suitable for instant hydration upon contact with hot water.

As used herein, the term “fruit source component” is defined as single or blended sources derived from a natural origin. It may include real fruit or other fruit analogs. The preferred fruit component is produced by freeze drying or pulverization to induce instant characteristics suitable for instant hydration upon contact with heated water.

“Fat source component” used herein means a triglyceride product that provide triglycerides physical characteristics to products and provide substantially fatty material. Fats and oils which may be used include anhydrous milk fat, butter, cream, cocoa butter, partially or fully hydrogenated vegetable fats and oils, such as, for example, cottonseed oil, coconut oil, corn oil, soybean oil, peanut oil, sunflower oil, palm kernel oil, and the like, and mixtures thereof, tallow and lard. Medium chain fatty acids or enzyme modified fat may also be utilized in the current invention. Fat source component may be configured to allow gradual calculated melting profile and different melting temperatures. Such fat may have a melting temperature range of about 120-210 F.

As used herein, the term “instant” means a food product ingredient that become soft, tender, soluble, pliable or malleable upon the addition of water.

As used herein the term “food sieve, filter, screen, strainer” means a filter, mesh, screen or strainer formed by a food product shaped as a strand, strip, band or ribbon or circles shapes or structured to prevent large food particle and solid food pieces from clogging the outlet needle of the brewing machine. The natural food filter is formed by a food product shaped as strand, strip, band, ribbon, and circle or structured in cross links, random or pre-configured arrangement.

### DETAILED DESCRIPTION OF THE INVENTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the subject components of the invention that are described in the publications, which components might be used in connection with the presently described invention.

The information provided below is not admitted to be prior art to the present invention, but is provided solely to assist the understanding of the reader.

The details of one or more embodiments of the invention are set forth in the accompanying drawings and the description below. Other features, objects, and advantages of the invention will be apparent from the description and drawings, and from the claims.

The present invention relates to novel method for producing instant meals and snacks that could be heated and cooked using a household coffee brewer and providing a mixture of solid food and liquid food. The cooking time is less than one minute.

It was observed that when regular solid food is cooked inside a cup or a capsule, either the solid food does not get fully cooked and softened for consumption or it clogs the bottom of the cup or capsule preventing the outflow of liquid.

The popular K-Cup is configured to penetrate a container with an inlet needle and outlet needle, inject a liquid into the container through the inlet needle, and drain liquid from the container through the outlet needle can be utilized in accordance with the teachings of the present disclosure. The K-Cup may or may not include paper filter inside. Having a filter is a common practice to prevent the solid food pieces or beverage insoluble parts from clogging the outlet needle of the brewing machine, which can result in a failed brew, and/or becoming trapped in the container in a soaked state, which can make removal of the food pieces very difficult after brewing.

The present inventor has surprisingly discovered that the inclusion of a step to add a natural food screen of pre-cooked food items works to stop solid food, moist food and particles from clogging the outlet needle thus permitting complete cooking cycle in such a short time.

It has been pleasantly surprising to find a novel approach to utilize common household beverage machines to cook liquid meals to be served as breakfast, lunch or dinner verities including savory, salty and sweet offerings. Soups with softened particulates maybe prepared utilizing the current invention in a range of flavors and textures. Chicken, turkey, beef, shrimp, lamb may be included in the cup to increase appeal and protein content. Breakfast items like oat meal, granola, and cereal maybe included with milk and sugar and other flavorings.

Furthermore, the invention teaches the criteria needed for selecting the solid food components and ingredients and how to create a natural functional filter made out of edible materials in a sequence of layering edible solid ingredients. The outer shell of the kit is pierceable to accommodate an injection of water into the container for combination with the soluble ingredients to produce a fluid which outflows from the bottom of the pierced container. The solid food pieces get rehydrated when infused with water. The capsule is configured with a peelable lid to allow a user to peel back the lid and pour the cooked solid contents, into the fluid portion and consumed. To create a cup of food, for example, the user can place the container into the brewing machine and press the brew button. The lid and the bottom of the capsule are pierced by the brewing machine's needles. Heated water flows through the capsule and mix with the soluble materials forming a liquid, which exits the container through the outflow needle of the brewing machine. When the water flow is complete, the container is picked up from the brewing machine and the peelable lid removed in order to transfer cooked solid food contents into the liquid portion.

The container, cup or capsule holds about one fluid ounce; therefore it is crucial to pack enough solid food ingredients to provide adequate meal. The brewing time is about 20-40 seconds depending on the desired fluid needed which ranges between about four to ten ounces. The container maybe manufactured from various resin materials or natural material, while the lid is made of aluminum foil and/or other resin material. It should be noted that other configuration of containers maybe suitable to utilize the current invention. For instance, a filter or bag material made from paper, textile or synthetic material without an actual outside wall or shell may be packed with the instant food sieve material and brewed resulting in a similar products. Suitable containers may also have a peelable bottom to open and dispose of food into other serving containers. Lids may have a tab to be used in removing the container from the brewing machine without touching the hot lid. A protective holder or sleeve may accommodate the container inside to avoid exposure to hot containers and injury. That protective sleeve also allow the squeezing the cooked food out of the container without a need for utensils. Plastic ring may be included inside the cup at the bottom to be removed before consumption of food; however such approach is not preferred due to the hazard of the presence of foreign material mixed with the edible food.

Lid or seal size may vary; the lid could be between around 0.5 to 4.0 inches. Lids may be placed on top and bottom of container, one of which to be removed after cooking to empty the food product into final consumption serving container. Container size could be any dimension, preferred size could be about 0.5 to 4.0 inches in top and bottom diameter.

Water temperature of the cooking device may ranges between 150 to 212 F and may also utilize high pressure water and steam.

One of the most important features of the present invention is that selected food components that work as a filter or screen are also edible and form a part of the finished food product. Therefore, it is imperative to select components with fast cooking characteristics, physical configuration and organoleptic performance.

The natural food filter could be made out of any or a combination of the starch source component, meat source component, fruit source component, vegetable source component and or/fat source component. Those sources have to be selected to cook, soften and be ready for eating in about 15 to 120 seconds and preferably in about 20-60 seconds. The preferred source components are produced by freeze drying, pulverization, instantiation, quick drying, pre-cooking frying or par-frying to induce instant characteristics suitable for instant hydration upon contact with heated water.

The density of the solid source component is an important feature of the current invention. For instance when noodles weighting about 75.5 grams per 100 grams noodles was used, (10 grams per capsule), the bottom of cup was clogged and no more liquid came out. Upon removing the lid, it was found that the noodle was soaked in water and not fully cooked. To the contrary, when noodles weighting about 36.3 grams per 100 grams noodles was used, the fluid completely drained out, there was no excess water inside the cup and noodles was cooked. Therefore, the range of acceptable density is about between 0.20-0.70, while the preferred specific gravity is about 0.25 to 0.50.

In case of soups, Ramen noodles and similar types are suitable food sieves. Pasta maybe manufactured in various shapes. It is important that the pasta or noodles have a light weight and large surface area. The light weight allows for fast cooking and produce tender finished product. The large surface area allows for fast hydration and more complete cooking within the cooking cycle. Both light weight and increased surface area allows for the noodle to be distributed throughout the liquid serving enhancing appeal and conveying a better value for the consumer. Pasta or noodles may be incorporated into kit as small pieces or a whole lump of pre shaped figure to fit at the bottom of capsule to work as a filter.

It is important to use pre-gelatinized and controlled starch release starch source components. Rice and pasta should be pre-treated or pre-processed to regulate the starch release from its particles in order to minimize the sticking of food items together and thus reducing the follow and path of hot water and also preventing the clogging of fluid exit port. Instant potatoes and mashed pre-formed potatoes that hydrate in about 20 to 60 seconds could be implemented in the current invention.

Meat, vegetable and fruit source components maybe shaped into strands or ribbons to allow fast hydration and prevention of food particles clogging the outpour opening. Such sources should be selected to allow for fast hydration, netting capabilities and structure formation of suitable food screens. Fat source components maybe selected in various shapes and melting points to provide proper melting after forming food strainers. Fat source components may also modify the taste and appearance attributes of the finished food.

Savory and salty meal and snacks maybe produced using the teaching of this current invention. Sweet treats that include real fruit pieces could be also produced by brewing contents over ice in a serving cup and dispensing thinly slice softened fruit particles on top of serving cup. Granola, oat meal and other grain cereals maybe used as food strainers. It is important to select quick cooking and hydrating types in suitable shapes to prevent clogging of brewing capsules.

The instant soluble food source component that forms the soluble portion of the meal may include a myriad of ingredients and features. Sweeteners, artificial sweeteners, salt, spices, colors, flavors, dairy powders, non-dairy powders, nutritional supplements, appetite suppressants, proteins, fats and bulking agents could be incorporated to provide functionality and organoleptic acceptance. The above may be used as powder, agglomerated, micro-particulate ingredients shaped into various configurations.

The instant soluble food source components may be used at about 0.2 to 90% of net weight of total ingredients inside the cup, preferable between about 10-30%. Solid food components may also be varied depending on the desired finished food product. About 13-17 grams of total ingredients maybe included in the cup container. In one preferred embodiment, Ramen Pasta was used at about 10 grams and soluble source component at about 5 grams to yield acceptable cup of hot soup with visible noodle presence and fulfilling soup. This source may be premixed with other components of just added on top of other ingredients.

In a preferred embodiment, food sieve or filter stop large food particles from blocking the liquid outpour opening. This novel approach eliminated the need for incorporating an artificial filter to stop the solid food from clogging the capsule opening. By eliminating the filter, the available space inside the cup is maximized allowing for incorporating larger weight of solid and liquid food materials to satisfy hunger and provide a good value to consumers.

As noted hereinabove, the configuration of solid food is crucial to form the natural food filter. In the preferred embodiment, the average length of elongated pasta or linguini style noodles may vary between about 2 mm to about 20 mm. The thickness of the solid food may vary between about 0.25 mm and 2.5 mm. When such instant pasta is used, it forms a random cross-linked structure that creates the natural food filter of the current invention. It is preferred to use filament or thin strands of the solid food component to form an efficient structural solid food screener. Thin food strands allows for instant softness and tenderness of solid food. Round and oval shapes maybe also are used provided it was shaped out of pre-cooked or pre-tenderized food material.

Natural food filter maybe placed at the bottom of cup or at any suitable from the bottom of cup. In Some cases, Ramen Noodles may be pre-formed and fried in a mold that emulates the shape of the cup or container and then deposited inside the cup as a total food filter or comprehensive food strainer.

A quick liquid and solid food container may be prepared by placing a pre-formed par-fried noodle network of noodles. The dimension of the network could be any desirable shape or type based on the cooking container that the network will be placed into. The preformed network may include other food components and ingredients that add taste, flavor or appearance to finished meal.

The soluble food source components blended in any sequence of addition and placed into the container at any stage of container filling. Starch, meat, vegetable and fat source components maybe mixed in any order and placed into the container at any stage of container filling. The abovementioned ingredients and components may be blended and filled using either a batch or continuous process system.

In the preferred embodiment, the instant shelf-stable meal or snack is packaged in plastic containers and sealed with foil lid. Standard and commercially available polystyrene cups with various barriers and liners may be filled and packaged as single serving containers to be used with commercial of household coffee serving machines. One widely used single serve coffee machine is Keurig Single Serve brewing system coffee machine. The plastic container holds about 29-31 grams of a food product. New brewer machine like VUE by Starbucks and other high pressure brewers maybe used to cook the food products in the current invention.

Advantages and embodiments of the methods described herein are further illustrated by the following examples; however, the particular conditions, processing schemes, materials, and amounts thereof recited in these examples, as well as other conditions and details, should not be construed to unduly limit this method. All percentages are by weight unless otherwise indicated.

### EXAMPLES

### Example 1

An instant liquid and solid food kit may be formed by blending about 6 grams of the instant soluble food source components and filling into cups, then adding about 10 grams of randomly mixed Ramen noodles to form natural food filter, placing a foil lid, sealing the foil lid.

Resultant soup was brewed in Keurig Brewer at about 190 F, collecting about 8 ounces of fluids from the bottom of the brewer, removing the soup cup, removing the lid, dumping the noodles on top of the liquid and consuming. The soup brewed well, all liquids exited from the opening at the bottom of cup, noodles was fully cooked and tender. Panelists reported high acceptability marks for the product.

### Example 2

Experiment 1 was repeated with replacing 3 grams of Ramen noodles with dehydrated chicken. That approach produced acceptable finished product with meat component.

### Example 3

Experiment 1 was repeated with replacing 4 grams of Ramen noodles with an instant vegetable. The resultant meal had an acceptable taste and aroma.

### Example 4

An instant liquid and solid food kit may be formed by blending 4 grams of the soluble source components and filling into cups, then adding 10 grams of Minute Rice to form natural food filter, placing a foil lid, sealing the foil lid.

Resultant soup was brewed in Keurig Brewer (240 ml serving), collecting fluids from the bottom of the brewer, removing the soup cup, removing the lid, dumping the noodles on top of the liquid and consuming. The soup brewed well, all liquids exited from the opening at the bottom of cup; rice was fully cooked and tender. Panelists reported high acceptability marks for the product.

### Example 5

A quick liquid and solid food container was prepared by placing a pre-formed par-fried noodle network of noodles inside the cup, blending about 6 grams of the instant soluble food source components and filling into cups, placing a foil lid, sealing the foil lid.

Resultant snack kit was brewed in Keurig Brewer at about 190 F, collecting about 7 ounces of fluids from the bottom of the brewer, removing the cup, removing the lid, dumping the noodles on top of the liquid and consuming. The pre-formed noodle network brewed well, all liquids exited from the opening at the bottom of cup, noodles was fully cooked and tender.

### Example 6

A quick liquid and solid breakfast dish was formed by blending 4 grams of sugar and 4 grams of dry milk, 7 grams instant oat meal and 2 grams of dried strawberry slices. After filling into capsules, capsules were sealed by placing a foil lid.

Resultant food was brewed in a brewer, by collecting fluids from the bottom of the brewer, removing the capsule, removing the lid, dumping the oat meal and strawberries on top of the liquid and consuming. Pre-gelatinized oat meal worked as a food filter.

### Example 7

A quick iced beverage containing fruit pieces was produced by blending 8 grams of sugar and 4 grams of dry milk, 7 grams instantized freeze dried strawberry and blueberry particles. After filling into capsules, capsules were sealed by placing a foil lid.

Resultant beverage was brewed in a brewer after selecting the volume of brewed liquid on machine to be about two ounces and adding about 8 ounces of crushed ice in the serving glass. The fruits were added on top of the liquid and ice mixture. Thinly sliced freeze dried fruits worked as a food screener.

### Example 8

A quick iced beverage containing fruit pieces was produced by blending 11 grams of sugar and 8 grams instantized Banana strips and blueberry particles. Capsules that contain top opening and bottom opening were used. Foil was sealed into the bottom opening; capsules were filled with the above product and sealed by placing a foil lid on top.

Resultant container was brewed in a brewer after selecting the volume of brewed liquid on machine to be about two ounces and adding about 8 ounces of crushed ice in the serving glass. The fruits were added on top of the liquid and ice mixture. The dried fruit strips and particles worked as a food screener.

The prior art documents mentioned herein are incorporated to the fullest extent permitted by law.

Unless otherwise defined, all technical and scientific terms used herein have the same meaning as commonly understood by one of ordinary skill in the art. Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and are not intended to be limiting.

### Equivalents

Those skilled in the art will recognize, or be able to ascertain using no more than routine experimentation, many equivalents to the specific embodiments of the invention described herein. Such equivalents are intended to be encompassed by the following claims.

What is claimed is:

1- A method for preparing an instant liquid and solid food composition comprising:
a- forming a natural food filter by placing solid source component inside a container
b- sealing the container with a lid
c- brewing the container in a brewing machine
d- collecting the fluid portion at the bottom of brewing machine
e- removing the lid
f- pouring cooked solid food into collected fluid portion

2- The method of claim 1 wherein the natural food filter has a specific gravity of about 0.35 to about 0.55.

3- The method of claim 1 wherein the natural food filter is formed by a food product shaped as strand, strip, band, ribbon, circle or structured in cross links, random or pre-configured arrangement.

4- A method for preparing an instant liquid and solid food composition comprising:
a- mixing one or more instant soluble food source component
b- forming a natural food filter by placing solid source component inside a container
c- adding the instant soluble food source component
d- sealing the container with a lid
e- passing hot water through the sealed container
f- collecting the fluid portion at the bottom of brewing machine
g- removing the lid
h- pouring cooked solid food into collected fluid portion

5- The method of claim 4 wherein the solid food source component is selected form a group consists of starch, meat, vegetable, fruit or fat source components or combination of thereof.

6- The method of claim 4 wherein the solid food source component has a specific gravity of about 0.25 to about 0.75.

7- The method of claim 5 wherein the starch source component is selected form a pre-cooked, cooked, par-fried, fried, freeze dried, instantized, dried starch source or combination of thereof.

8- The method of claim 5 wherein the starch food source component is Ramen Style Noodles.

9- The method of claim 5 wherein the starch source component is instant rice.

10- The method of claim 5 wherein the vegetable source component is an instantly softened vegetable.

11- The method of claim 5 wherein the fruit source component is an instantly tenderized fruit.

12- The method of claim 5 wherein the fat source component is selected from anhydrous milk fat, butter, cream, cocoa butter, partially or fully hydrogenated vegetable fats and oils, tallow, lard, medium chain fatty acids, enzyme modified fat or combination of thereof.

13- A method for structuring an instant food sieve comprising:
a- Selecting a fast softening food source component
b- forming a screener by layering food source components
c- including the screener in a cooking container
d- cooking the container in a cooking machine

14- The method of claim 13 wherein the fast softened food is selected form a group consists of starch, meat, vegetable, fruit and fat or combination of thereof.

15- The method of claim 13 wherein the starch is selected form a pre-cooked, cooked, par-fried, fried, freeze dried, instantized, dried starch source or combination of thereof.

16- The method of claim 13 wherein the starch is pre-formed noodles.

17- The method of claim 13 wherein the starch is instant rice.

18- The method of claim 13 wherein the vegetable is an instant softened vegetable.

19- The method of claim 13 wherein the fruit is an instant fruit.

20- The method of claim 13 wherein the fat has a melting temperature of about 110-200 F.

21- The method of claim 13 wherein the fast softening food source component has a specific gravity of about 0.35 to about 0.55.

22- The method of claim 13 wherein the fast softening food source component is formed by a food product shaped as strand, strip, band, ribbon, circle or structured in cross links, random or pre-configured arrangement.

23- A kit comprising:
a- instant soluble food source component
b- solid food source component
c- container
d- sealing lid

24- The kit of claim 23 wherein the instant soluble food source component is selected form food product ingredients comprising soluble, instant, dried, freeze dried or spray dried coloring, flavorings, salting, sweetening, texturing and nutritional agents or combination of thereof.

25- The kit of claim 23 wherein the solid food source component is selected form a group consists of starch, meat, vegetable, fruit or fat source components or combination of thereof.

26- The kit of claim 25 wherein the starch source component is selected form a pre-cooked, cooked, par-fried, fried, freeze dried, instantized, dried starch source or combination of thereof.

27- The kit of claim 25 wherein the starch food source component is Ramen Style Noodles.

23- The kit of claim 25 wherein the starch source component is instant rice.

28- The kit of claim 25 wherein the vegetable source component is an instantly softened vegetable.

29- The kit of claim 25 wherein the fruit source component is an instantly tenderized fruit.

30- The kit of claim 25 wherein the fat source component is selected from anhydrous milk fat, butter, cream, cocoa butter, partially or fully hydrogenated vegetable fats and oils, tallow, lard, medium chain fatty acids, enzyme modified fat or combination of thereof.

31- The kit of claim 23 wherein the solid food source component has a specific gravity of about 0.35 to about 0.55.

32- The kit of claim 23 wherein the solid food source component formed by a food product shaped as strand, strip, band, ribbon, circle or structured in cross links, random or pre-configured arrangement.
